(19) United States
(12) Patent Application Publication
(10) Pub. No.: US 2010/0332842 A1
(43) Pub. Date: Dec. 30, 2010

(54) DETERMINING A MOOD OF A USER BASED ON BIOMETRIC CHARACTERISTIC(S) OF THE USER IN AN ONLINE SYSTEM

(75) Inventors: Chris Kalaboukis, San Jose, CA (US); Jonathan Matkowsky, Palo Alto, CA (US)

Correspondence Address: FIALA & WEAVER P.L.L.C.;C/O CPA GLOBAL, P.O. BOX 52050, MINNEAPOLIS, MN, 55402, US

(73) Assignee: YAHOO! INC., Sunnyvale, CA (US)

(21) Appl. No.: 12/494,984

(22) Filed: Jun. 30, 2009

(51) Int. Cl. H04L 9/32; G06F 17/30

(52) U.S. Cl. 713/186; 707/759; 707/769

(57) ABSTRACT

Techniques are described herein that enable a determination of a user's mood based on biometric characteristic(s) of the user in an online system. An online system is a system that supports the transfer of information via the Internet. The mood of the user at a time instance (i.e., a mood instance) is determined based on the biometric characteristic(s) of the user and a substantially real-time instance(s) associated with the user. A substantially real-time instance associated with the user is any occurrence with respect to the user that is determined in substantially real-time. The mood instance of the user and the substantially real-time instance that is associated with the user may (or may not) occur at the same time instance. Online content may be provided to the user and/or action(s) may be recommended to the user in response to determining the mood instance of the user.

### BACKGROUND OF THE INVENTION

1. Field of the Invention

The present invention generally relates to biometrics. In particular, the present invention is related to determining the mood of a user based on biometric characteristic(s) of the user.

2. Background

Online systems are systems that support the transfer of information via the Internet. Information that is transferred via the Internet is commonly referred to as online content. Online content is often transferred from Web servers to user systems in response to requests from the user systems. A user system is a computer, a personal digital assistant (PDA), or any other processing system, including one or more processors, which is capable of interpreting online content that is provided by a Web server. A Web server is a computer or other processing system, including one or more processors, which is capable of providing online content to user system(s).

Some Web servers may be configured to determine the intent of a user with respect to a request for online content that is provided by the user. For instance, determining the intent of the user may enable the Web server to provide online content that is more relevant to the user. The Web server may derive the user's intent based on a variety of factors, such as the keystrokes, mouse movements, and/or clicks that are performed by the user to generate the request. However, such factors may not sufficiently enable the Web server to determine the user's intent.

Information regarding the user's mood may enable the Web server to more accurately determine the intent of the user with respect to a request for online content that is provided by the user. For instance, the Web server may execute a software program that enables the user to set a value of an indicator to specify the mood of the user. The Web server may provide online content to the user based on the mood that is specified by the value of the indicator. However, the mood that is specified by the user and the actual mood of the user may differ. For example, the user may not update the value of the indicator when the mood of the user changes. In accordance with this example, the mood of the user may change relatively frequently based on a variety of events that may occur within a relatively short time period, which may increase the likelihood of discrepancies between the user's specified mood and the user's actual mood.

Thus, systems, methods, and computer program products are needed that are capable of determining a mood of a user in an online system without requiring the user to explicitly change the value of an indicator with each change of the user's mood.

### BRIEF SUMMARY OF THE INVENTION

Various approaches are described herein for, among other things, determining a user's mood based on biometric characteristic(s) of the user in an online system. Examples of biometric characteristics includes but are not limited to heart rate, perspiration rate, temperature, resistance, scent, fingerprint, deoxyribonucleic acid (DNA), facial geometry, hand geometry, palm geometry, iris pattern, etc. The mood of the user at a time instance is determined based on the biometric characteristic(s) of the user and substantially real-time instance(s) associated with the user. The mood of the user at a time instance is referred to as a mood instance.

A substantially real-time instance associated with the user is any occurrence with respect to the user that is determined at a time instance in substantially real-time. For example, a substantially real-time instance associated with the user may include a substantially real-time media instance, a substantially real-time geographic instance, or any other suitable substantially real-time instance.

Example substantially real-time media instances include but are not limited to the user typing or sending a message (e.g., an email, a short message service (SMS) message, an instant message (IM), a tweet message, etc.); the user receiving a message; the user participating in a telephone call, a chat session, a video conference, etc.; the user consuming online content (e.g., a video, an image, an RSS feed, a Web page, etc.); the user playing a video game; etc. For instance, a substantially real-time instance may pertain to the user using a type (e.g., smiling, frowning, winking, etc.) of emoticon in a message, chat session, etc.; the user using a type (e.g., stern, inflammatory, profane, etc.) of language in a message, telephone call, chat session, video conference, etc.; the user sending or receiving a message with respect to a particular person; the user participating in a telephone call, a chat session, a video conference, etc. with a particular person; the user consuming a type of online content (e.g., an article regarding politics, a video of a car chase, an online advertisement for a diet pill, etc.); the user viewing an image or video that includes particular colors and/or imagery; the user playing a particular video game or a type of video game; and so on.

A substantially real-time geographic instance indicates a geographic location of the user that is determined at a time instance in substantially real-time. For instance, the substantially real-time geographic instance may indicate that the user is in a particular country, state, or city, at school, in a particular class room of the school, at a concert venue, at a particular friend's house, in a cookie aisle of a grocery store, etc.

The mood instance of the user and the substantially real-time instance that is associated with the user may (or may not) occur at the same time instance. Online content may be provided to the user and/or action(s) may be recommended to the user in response to determining the mood instance of the user.

An example method is described in which a biometric indicator that specifies biometric characteristic(s) of a user is received. A mood instance of the user that corresponds to a time instance is determined at a Web server in an online system using processor(s) of the Web server. The first mood instance is based on the biometric characteristic(s) and substantially real-time instance(s) that are associated with the user.

Another example method is described in which biometric characteristic(s) of a user are sensed (e.g., detected, measured, etc.). A biometric indicator that specifies the biometric characteristic(s) is provided to a Web server in an online system. A real-time instance indicator that specifies substantially real-time instance(s) that are associated with the user is provided to the Web server. Online content that is received from the Web server is processed at a user system in the online system using one or more processors of the user system. The online content is based on the biometric characteristic(s) of the user and the substantially real-time instance(s) that are associated with the user.

An example Web server is also described. The Web server includes a receiving module and a mood module. The receiving module is configured to receive a biometric indicator that specifies biometric characteristic(s) of a user. The mood module is configured to determine a mood instance of the user that corresponds to a time instance based on the biometric characteristic(s) and substantially real-time instance(s) that are associated with the user.

An example user system is also described. The user system includes biometric sensor(s), an indicator module, and an online content module. The biometric sensor(s) are configured to sense biometric characteristic(s) of a user. The indicator module is configured to provide a biometric indicator that specifies the biometric characteristic(s) to a Web server in an online system. The indicator module is further configured to provide a real-time instance indicator that specifies substantially real-time instance(s) that are associated with the user to the Web server. The online content module is configured to process online content that is received from the Web server based on the biometric characteristic(s) of the user and the substantially real-time instance(s) that are associated with the user.

Further features and advantages of the disclosed technologies, as well as the structure and operation of various embodiments, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example online system in accordance with an embodiment described herein.

FIG. 2 depicts a flowchart of a method for providing information regarding biometric characteristic(s) of a user to a Web server in accordance with an embodiment described herein.

FIG. 3 is a block diagram of an example implementation of a user system shown in FIG. 1 in accordance with an embodiment described herein.

FIGS. 4A-4F depict respective portions of a flowchart of a method for determining a mood of a user based on biometric characteristic(s) of the user in accordance with an embodiment described herein.

FIGS. 5, 7, 9, 11, and 13 are block diagrams of example implementations of a Web server shown in FIG. 1 in accordance with embodiments described herein.

FIG. 6 depicts a flowchart of a method for determining a mood instance of a user in accordance with an embodiment described herein.

FIG. 8 depicts a flowchart of a method for providing search results to a user based on a mood of the user in accordance with an embodiment described herein.

FIG. 10 depicts a flowchart of a method for adjusting fear level of a video game in accordance with an embodiment described herein.

FIG. 12 depicts a flowchart of a method for providing online content to a user based on a mood of the user in accordance with an embodiment described herein.

FIG. 14 is a block diagram of a computer that may be used to implement one or more aspects of the present invention.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate example embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Example embodiments enable a determination of a user's mood based on biometric characteristic(s) of the user in an online system. Examples of biometric characteristics includes but are not limited to heart rate, perspiration rate, temperature, resistance, scent, fingerprint, deoxyribonucleic acid (DNA), facial geometry, hand geometry, palm geometry, iris pattern, etc. The user's mood may change instantaneously. Thus, the mood of the user at a time instance is determined based on the biometric characteristic(s) of the user and substantially real-time instance(s) associated with the user. The mood of the user at a time instance is referred to as a mood instance.

A substantially real-time instance associated with the user is any occurrence with respect to the user that is determined at a time instance in substantially real-time. For example, a substantially real-time instance associated with the user may include a substantially real-time media instance, a substantially real-time geographic instance, or any other suitable substantially real-time instance.

Example substantially real-time media instances include but are not limited to the user typing or sending a message (e.g., an email, a short message service (SMS) message, an instant message (IM), a tweet message, etc.); the user receiving a message; the user participating in a telephone call, a chat session, a video conference, etc.; the user consuming online content (e.g., a video, an image, an RSS feed, a Web page, etc.); the user playing a video game; etc. For instance, a substantially real-time instance may pertain to the user using a type (e.g., smiling, frowning, winking, etc.) of emoticon in a message, chat session, etc.; the user using a type (e.g., stern, inflammatory, profane, etc.) of language in a message, telephone call, chat session, video conference, etc.; the user sending or receiving a message with respect to a particular person; the user participating in a telephone call, a chat session, a video conference, etc. with a particular person; the user consuming a type of online content (e.g., an article regarding politics, a video of a car chase, an online advertisement for a diet pill, etc.); the user viewing an image or video that includes particular colors and/or imagery; the user playing a particular video game or a type of video game; and so on.

A substantially real-time geographic instance indicates a geographic location of the user that is determined at a time instance in substantially real-time. For instance, the substantially real-time geographic instance may indicate that the user is in a particular country, state, or city, at school, in a particular class room of the school, at a concert venue, at a particular friend's house, in a cookie aisle of a grocery store, etc.

If the mood instance of the user and the substantially real-time instance that is associated with the user occur at the same time instance, the mood instance may trigger (e.g., cause) the substantially real-time instance, or vice versa. It should be recognized, however, that the mood instance of the user and the substantially real-time instance that is associated with the user may not occur at the same time instance. For example, the mood instance may occur before the substantially real-time instance. In accordance with this example, the mood instance may trigger the substantially real-time instance. In another example, the mood instance may occur after the substantially real-time instance. In accordance with this example, the substantially real-time instance may trigger the mood instance.

According to some example embodiments, online content is provided to the user in response to determining the mood instance of the user. For instance, if the mood instance of the user indicates that the user is in a sad mood, online content that the user may find humorous may be provided to the user. In some example embodiments, action(s) are recommended to the user in response to determining the mood instance of the user. For example, if the user is in an angry mood, a recommendation may be provided to the user to perform an action that is known to calm the user (e.g., walking the user's dog). In accordance with this example, if conversations between the user and the user's brother are known to anger the user and a determination is made that the user is dialing the brother's telephone number, a recommendation may be provided that the user not call the user's brother (or that the user wait until the user's mood becomes less angry).

### II. Example Embodiments for Determining Mood of a User Based on Biometric Characteristic(s) of the User

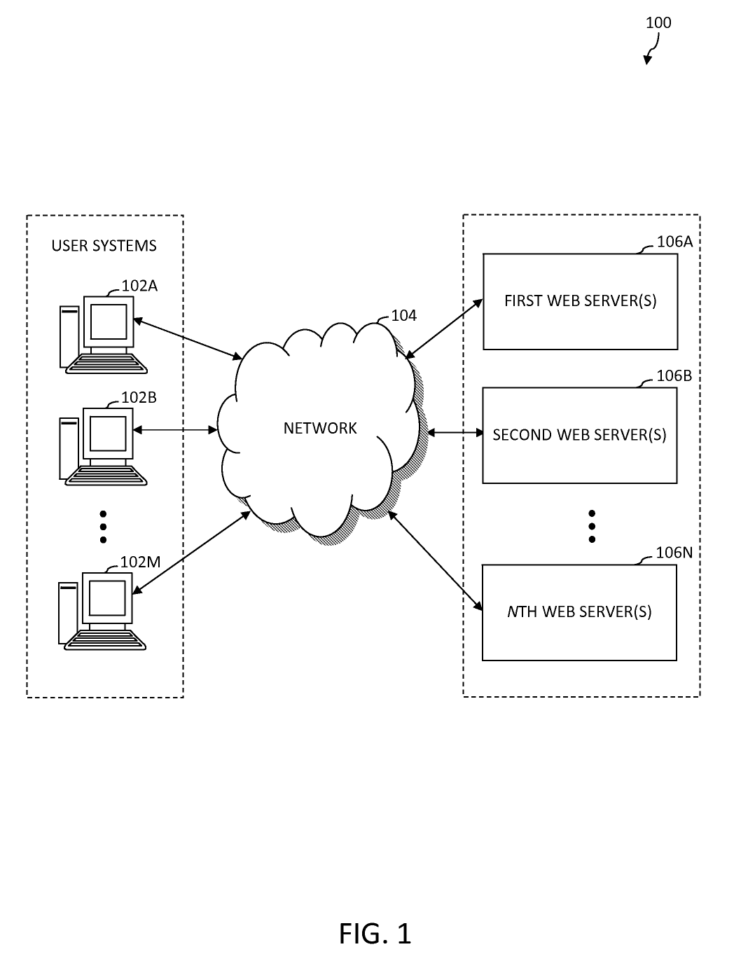

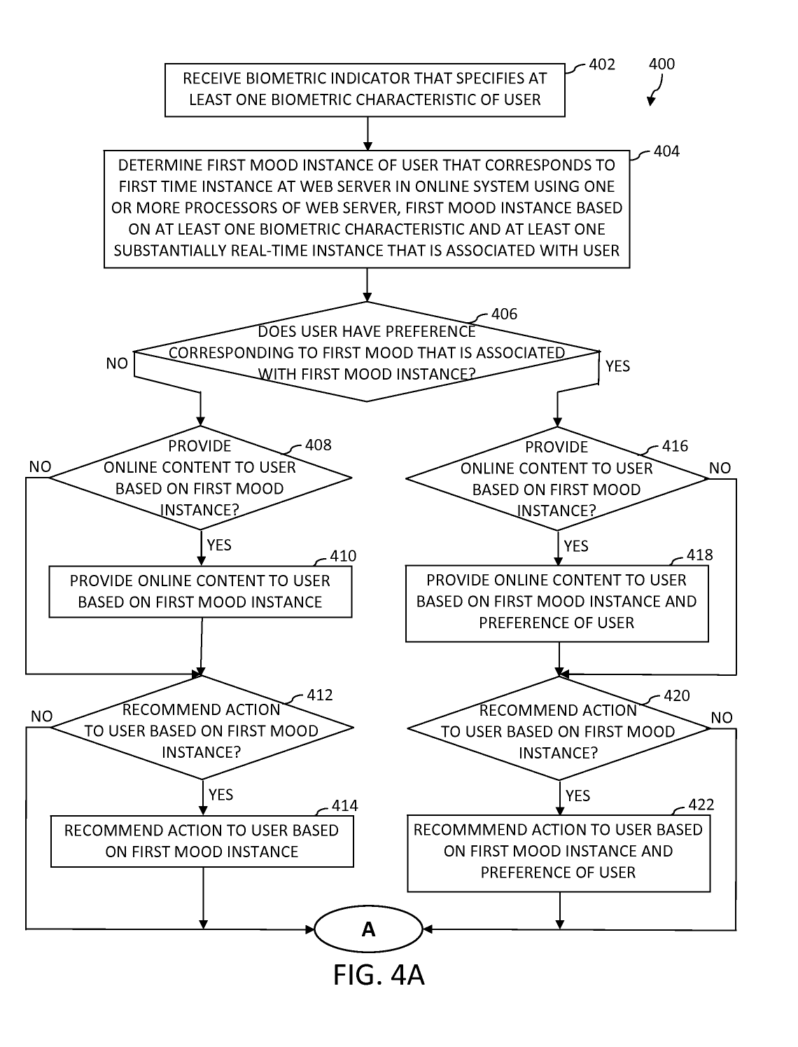

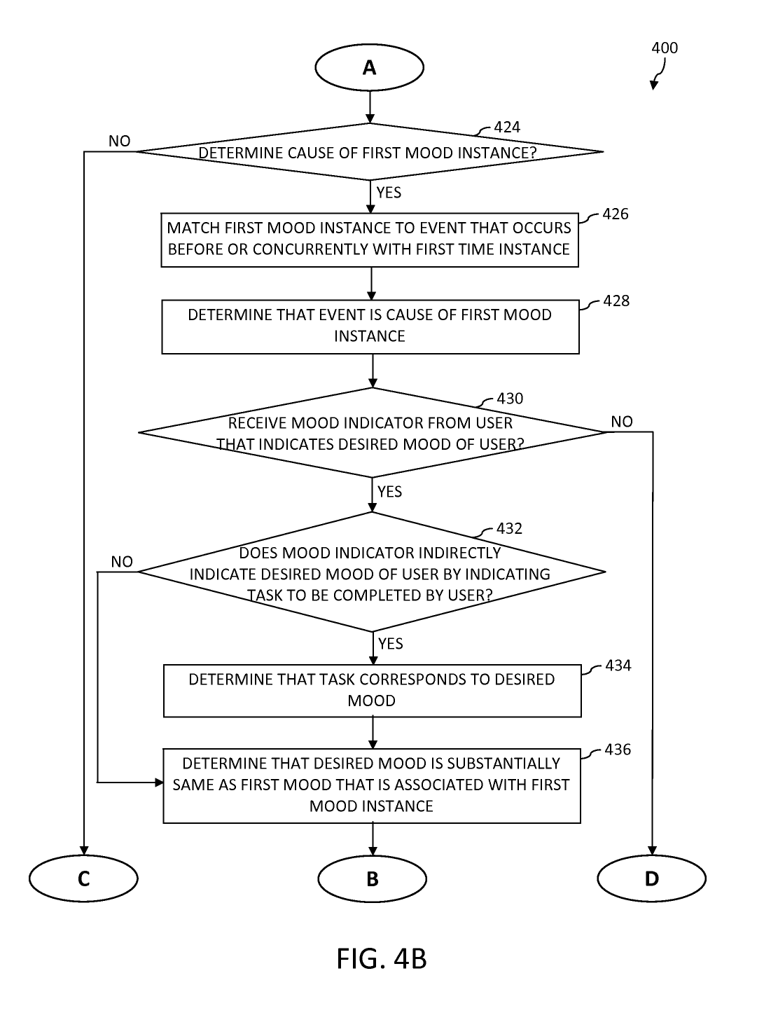

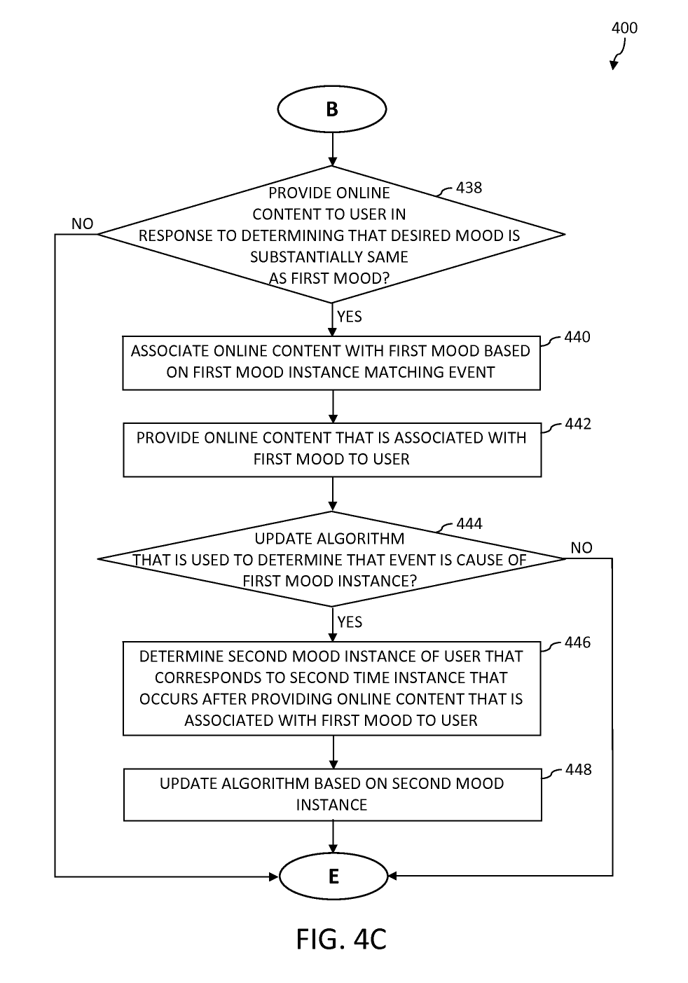

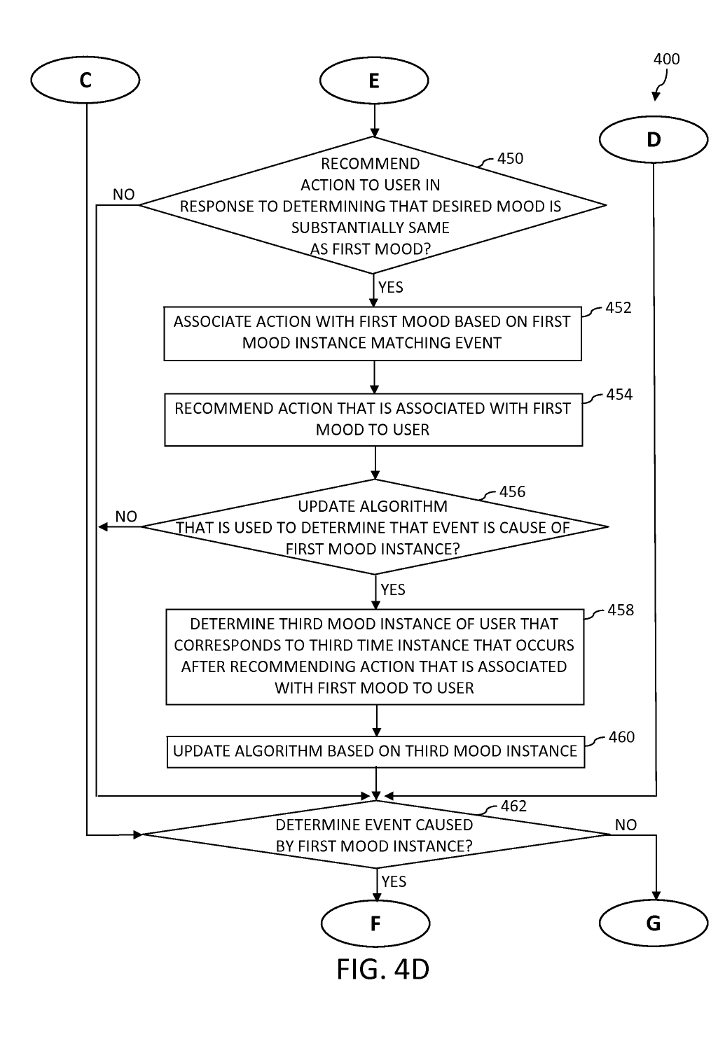

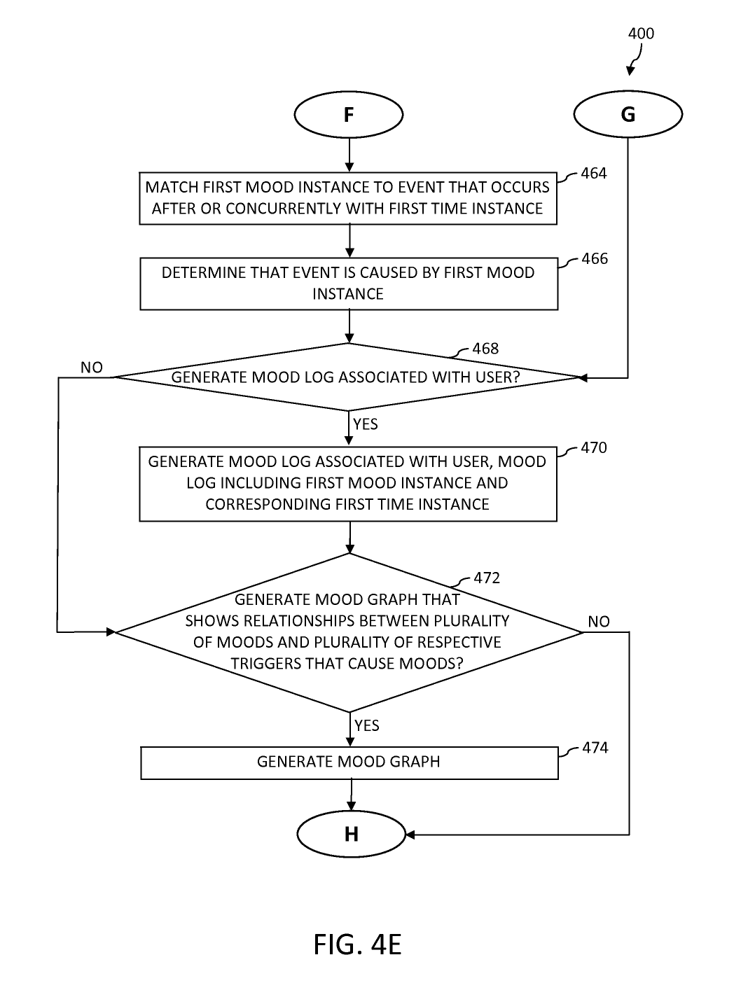

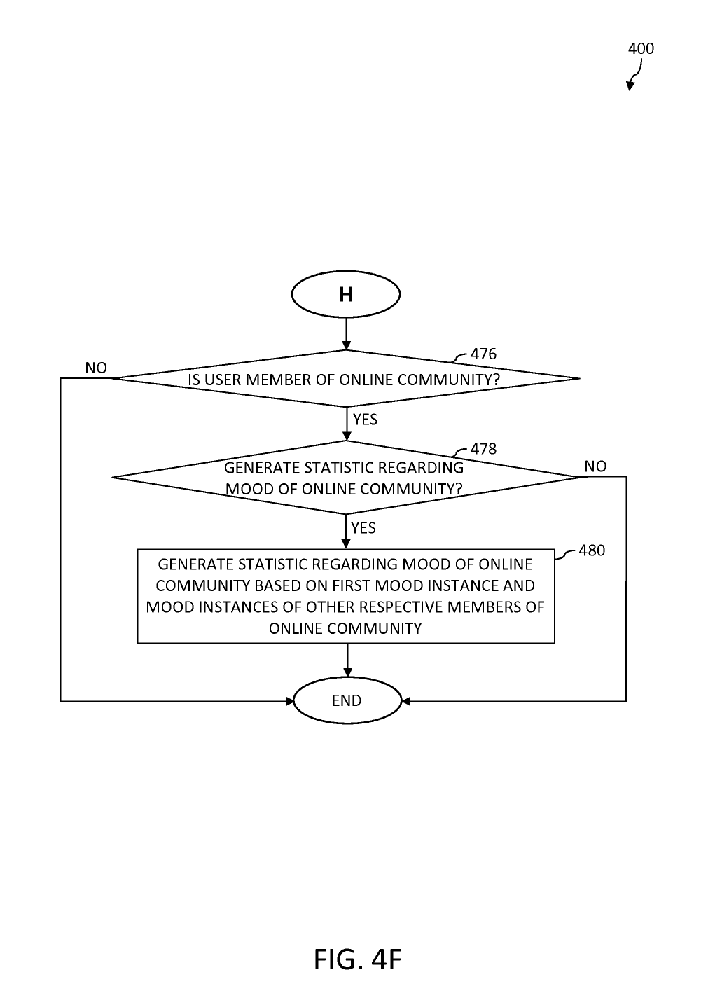

FIG. 1 is a block diagram of an example online system 100 in accordance with an embodiment described herein. Generally speaking, online system 100 operates to provide information (a.k.a. online content) to users via the Internet in response to hypertext transfer protocol (HTTP) requests provided by the users. The information may include Web pages, videos, images, other types of files, output of executables, etc. In accordance with example embodiments, online system 100 operates to provide information to users and/or to recommend actions to users based on the moods of the users. Techniques for determining the moods of users are discussed below with respect to FIGS. 4A-4F, and 5-13.

As shown in FIG. 1, online system 100 includes a plurality of user systems 102A-102M, a network 104, and a plurality of Web servers 106A-106N. Communication among user systems 102A-102M and Web servers 106A-106N is carried out over network 104 using well-known network communication protocols. Network 104 includes the Internet, and may include sub-networks, such as wide-area networks (WANs), local area networks (LANs), and the like.

User systems 102A-102M are computers or other processing systems, each including one or more processors, that are capable of interpreting online content that is provided by Web servers 106A-106N. User systems 102A-102M are capable of accessing Web sites hosted by Web servers 104A-104N, so that user systems 102A-102M may access information that is available via the websites. User systems 102A-102M are configured to provide HTTP requests to Web servers 106A-106N for requesting information stored on (or otherwise accessible via) Web servers 106A-106N. For instance, a user may initiate an HTTP request for information using a client (e.g., a Web browser, a Web crawler, etc.) deployed on a user system 102 that is owned by or otherwise accessible to the user.

At least one of the user systems 102A-102M is configured to sense biometric characteristic(s) of a user. Examples of biometric characteristics includes but are not limited to heart rate, perspiration rate, temperature, resistance, scent, fingerprint, deoxyribonucleic acid (DNA), facial geometry, hand geometry, palm geometry, iris pattern, etc. For example, a user system may provide a biometric indicator that specifies biometric characteristic(s) of a user to a Web server (e.g., any of Web servers 106A-106N). The user system may further provide a real-time instance indicator that specifies substantially real-time instance(s) that are associated with the user to the Web server. A substantially real-time instance associated with the user is any occurrence with respect to the user that is determined at a time instance in substantially real-time.

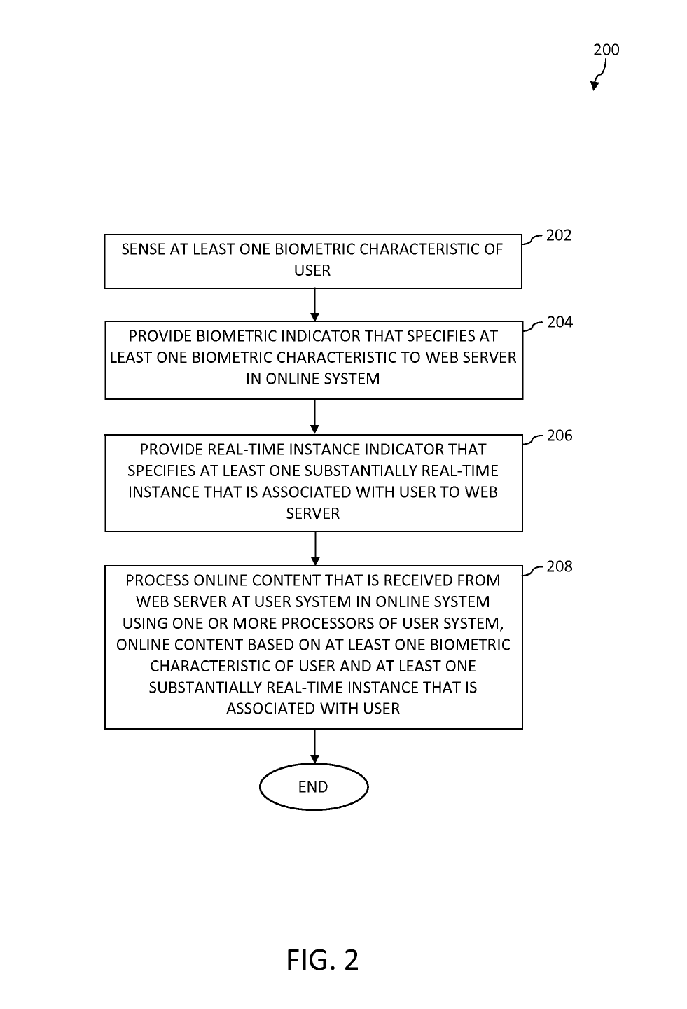

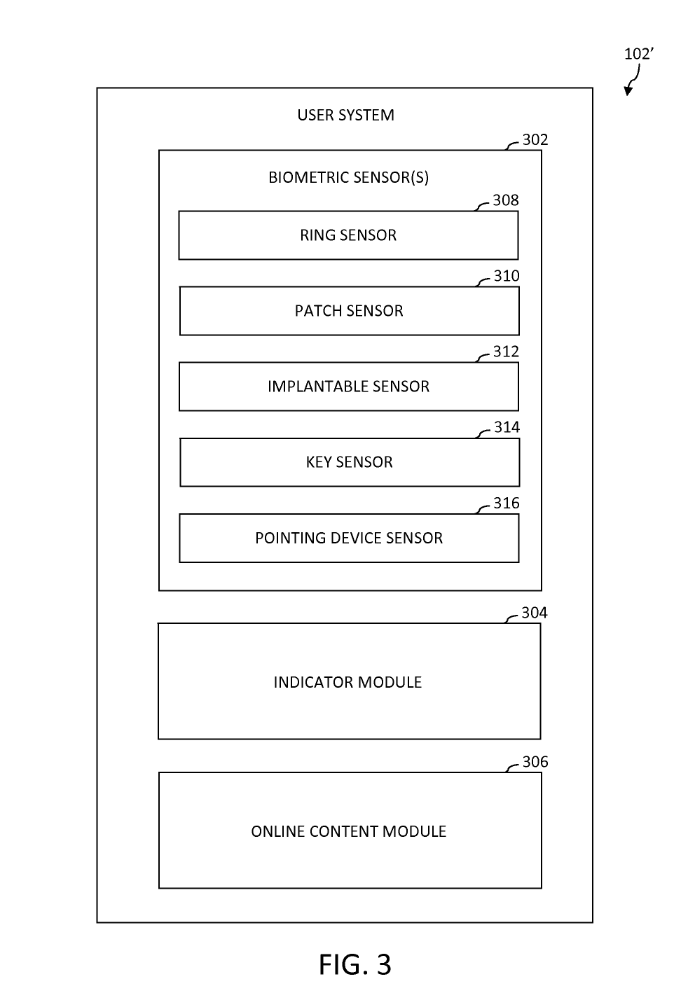

The biometric indicator and/or the real-time instance indicator may be incorporated into HTTP request(s), though the scope of the example embodiments is not limited in this respect. The user system may receive online content from the Web server that is based on the biometric characteristic(s) of the user and the substantially real-time instance(s) that are associated with the user. The user system may process the online content, so that it may be consumed by the user, for example. Techniques for providing information to a Web server to facilitate a determination of a mood of a user are discussed in further detail below with reference to FIGS. 2 and 3.

Web servers 106A-106N are computers or other processing systems, each including one or more processors, that are capable of providing online content to user systems 102A-102M. Web servers 106A-106N are configured to host respective Web sites, so that the Web sites are accessible to users of online system 100. Web servers 106A-106N are further configured to execute software programs that provide online content to users in response to receiving hypertext transfer protocol (HTTP) requests from users. The software programs that are executing on Web servers 106A-106N may provide Web pages that include interface elements (e.g., buttons, hyperlinks, etc.) that a user may select for accessing the other types of online content (e.g., videos, images, other types of files, output of executables residing on the Web servers, etc.). The Web pages may be provided as hypertext markup language (HTML) documents and objects (e.g., files) that are linked therein, for example.

At least one of the Web servers 106A-106N is configured to determine a mood of a user based on biometric characteristic(s) of the user and substantially real-time instance(s) that are associated with the user. For example, a Web server may receive a biometric indicator from a user system (e.g., any of user systems 102A-102M) that specifies biometric characteristic(s) of a user. The Web server may further receive a real-time instance indicator that specifies substantially real-time instance(s) that are associated with the user. Upon receiving the biometric indicator, the Web server may determine the mood of the user at a time instance based on the biometric characteristic(s) and further based on substantially real-time instance(s) that are associated with the user. Techniques for determining a mood of a user are discussed in further detail below with reference to FIGS. 4A-4F, and 5-13.

One type of software program that may be executed by any one or more of Web servers 106A-106N is a Web search engine. A Web search engine searches for information on the World Wide Web (WWW) based on search queries that are provided by users. For instance, the Web search engine may search among Web servers 106A-106N for the requested information. Upon discovering instances of information that are relevant to a search query, the Web search engine ranks the instances based on their relevance to the search query. In accordance with example embodiments, the search results may be ranked based on a mood of a user who provided the search query. The Web search engine provides a list that includes each of the instances in an order that is based on the respective rankings of the instances. The list may be referred to as the search results corresponding to the search query.

It will be recognized that any one or more user systems 102A-102M may communicate with any one or more Web servers 106A-106N. Each of the user systems 102A-102M may include any client-enabled system or device, including but not limited to a desktop computer, a laptop computer, a personal digital assistant, a cellular telephone, or the like.

FIG. 2 depicts a flowchart 200 of a method for providing information regarding biometric characteristic(s) of a user to a Web server in accordance with an embodiment described herein. Flowchart 200 is described from the perspective of a user system. Flowchart 200 may be performed by any of user systems 102A-102M of online system 100 shown in FIG. 1, for example. For illustrative purposes, flowchart 200 is described with respect to a user system 102′ shown in FIG. 3, which is an example of a user system 102, according to an embodiment. In this document, whenever a prime is used to modify a reference number, the modified reference number indicates an example (or alternate) implementation of the element that corresponds to the reference number.

As shown in FIG. 3, user system 102′ includes biometric sensor(s) 302, an indicator module 304, and an online content module 306. Biometric sensor(s) 302 includes a ring sensor 308, a patch sensor 310, an implantable sensor 312, a key sensor 314, and a pointing device sensor 316. Further structural and operational embodiments will be apparent to persons skilled in the relevant art(s) based on the discussion regarding flowchart 200. Flowchart 200 is described as follows.

As shown in FIG. 2, the method of flowchart 200 begins at step 202. In step 202, at least one biometric characteristic of a user is sensed. Examples of biometric characteristics includes but are not limited to heart rate, perspiration rate, temperature, resistance, scent, fingerprint, deoxyribonucleic acid (DNA), facial geometry, hand geometry, palm geometry, iris pattern, etc. In an example implementation, biometric sensor(s) 302 sense the at least one biometric characteristic of the user.

A biometric sensor is a device that is configured to sense (e.g., detect, measure, etc.) a biometric characteristic of a user. For instance, any one or more of the ring sensor 308, patch sensor 310, implantable sensor 312, key sensor 314, and/or pointing device sensor 316 may sense the at least one biometric characteristic of the user. A ring sensor is a biometric sensor that is configured to be placed around a portion of a user's body. For instance, ring sensor 308 may be placed around a user's finger, hand, wrist, elbow, arm, toe, foot, ankle, knee, leg, abdomen, chest, neck, head, or any other portion of the user's body. A patch sensor is a biometric sensor that is configured to adhere to a user's skin. For example, patch sensor 310 may be placed on the user's skin. An implantable sensor is a biometric sensor that is configured to be implanted at least partially beneath a user's skin. For instance, implantable sensor 312 may be implanted at least partially beneath the user's skin. A key sensor is a biometric sensor that is incorporated into a key of a keyboard, keypad, or any other input device that includes one or more keys. For example, key sensor 314 may be incorporated into a key of user system 102′. A pointing device sensor is a biometric sensor that is incorporated into a pointing device. Examples of pointing devices include but are not limited to a mouse, a touchpad, a pointing stick, a stylus, a touch screen, a joystick, a trackball, a Wii® remote (developed by Nintendo Company Ltd.), etc. For instance, pointing device sensor 316 may be incorporated into a pointing device of user system 102′.

It will be recognized that biometric sensor(s) 302 may not include one or more of ring sensor 308, patch sensor 310, implantable sensor 312, key sensor 314, and/or pointing device sensor 316. Furthermore, biometric sensor(s) 302 may include biometric sensors in addition to or in lieu of ring sensor 308, patch sensor 310, implantable sensor 312, key sensor 314, and/or pointing device sensor 316.

At step 204, a biometric indicator that specifies the at least one biometric characteristic is provided to a Web server in an online system. In an example implementation, indicator module 304 provides the biometric indicator to the Web server. For example, indicator module 304 may automatically generate the biometric indicator in response to the at least one biometric characteristic being sensed at step 202. In another example, indicator module 304 may generate the biometric indicator in response to a request from the Web server.

At step 206, a real-time instance indicator that specifies at least one substantially real-time instance that is associated with the user is provided to the Web server. A substantially real-time instance associated with the user is any occurrence with respect to the user that is determined at a time instance in substantially real-time. For example, a substantially real-time instance associated with the user may include a substantially real-time media instance, a substantially real-time geographic instance, or any other suitable substantially real-time instance.

Example substantially real-time media instances include but are not limited to the user typing or sending a message (e.g., an email, a short message service (SMS) message, an instant message (IM), a tweet message, etc.); the user receiving a message; the user participating in a telephone call, a chat session, a video conference, etc.; the user consuming online content (e.g., a video, an image, an RSS feed, a Web page, etc.); the user playing a video game; etc. For instance, a substantially real-time instance may pertain to the user using a type (e.g., smiling, frowning, winking, etc.) of emoticon in a message, chat session, etc.; the user using a type (e.g., stern, inflammatory, profane, etc.) of language in a message, telephone call, chat session, video conference, etc.; the user sending or receiving a message with respect to a particular person; the user participating in a telephone call, a chat session, a video conference, etc. with a particular person; the user consuming a type of online content (e.g., an article regarding politics, a video of a car chase, an online advertisement for a diet pill, etc.); the user viewing an image or video that includes particular colors and/or imagery; the user playing a particular video game or a type of video game; and so on.

A substantially real-time geographic instance indicates a geographic location of the user that is determined at a time instance in substantially real-time. For instance, the substantially real-time geographic instance may indicate that the user is in a particular country, state, or city, at school, in a particular class room of the school, at a concert venue, at a particular friend's house, in a cookie aisle of a grocery store, etc.

In an example implementation, indicator module 304 provides the real-time instance indicator to the Web server. For example, indicator module 304 may automatically generate the real-time instance indicator in response to detecting the substantially real-time instance. In another example, indicator module 304 may generate the real-time instance indicator in response to a request from the Web server.

In yet another example, the Web server may use the biometric indicator and the real-time instance indicator to determine a mood of the user. In accordance with this example, providing the biometric indicator and the real-time instance indicator to the Web server may enable the Web server to provide online content to the user and/or recommend action(s) to the user based on the mood of the user.

At step 208, online content that is received from the Web server is processed at a user system in the online system using one or more processors of the user system. The online content is based on the at least one biometric characteristic of the user and the at least one substantially real-time instance that is associated with the user. In accordance with the example above in which providing the biometric indicator and the real-time instance indicator to the Web server enables the Web server to determine the mood of the user, the online content may be based on the mood of the user. In an example implementation, online content module 306 processes the online content that is received from the Web server.

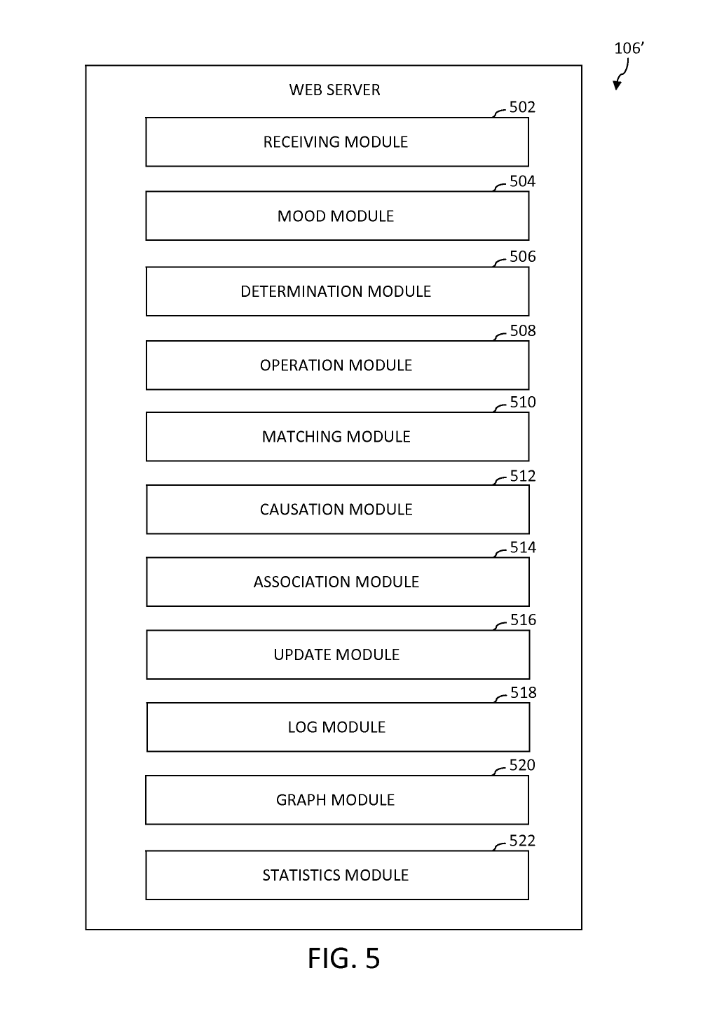

FIGS. 4A-4F depict respective portions of a flowchart 400 of a method for determining a mood of a user based on biometric characteristic(s) of the user in accordance with an embodiment described herein. Flowchart 400 is described from the perspective of a Web server. Flowchart 400 may be performed by any of Web servers 106A-106N of online system 100 shown in FIG. 1, for example. For illustrative purposes, flowchart 400 is described with respect to a Web server 106′ shown in FIG. 5, which is an example of a Web server 106, according to an embodiment. As shown in FIG. 5, Web server 106′ includes a receiving module 502, a mood module 504, a determination module 506, an operation module 508, a matching module 510, a causation module 512, an association module 514, an update module 516, a log module 518, a graph module 520, and a statistics module 522. Further structural and operational embodiments will be apparent to persons skilled in the relevant art(s) based on the discussion regarding flowchart 400. Flowchart 400 is described as follows.

As shown in FIG. 4A, the method of flowchart 400 begins at step 402. In step 402, a biometric indicator that specifies at least one biometric characteristic of a user is received. In an example implementation, receiving module 502 receives the biometric indicator.

At step 404, a first mood instance of the user that corresponds to a first time instance is determined at a Web server in an online system using one or more processors of the Web server. The first mood instance is based on the at least one biometric characteristic and at least one substantially real-time instance that is associated with the user. In an example implementation, mood module 504 determines the first mood instance of the user.

If the first mood instance of the user and the at least one substantially real-time instance that is associated with the user both occur at the first time instance, the first mood instance may be deemed to have triggered the at least one substantially real-time instance, or vice versa. It should be recognized, however, that the first mood instance of the user and the at least one substantially real-time instance that is associated with the user may not occur at the same time instance. For example, the first mood instance may occur before the at least one substantially real-time instance. In accordance with this example, the first mood instance may be deemed to have triggered the at least one substantially real-time instance. In another example, the first mood instance may occur after the at least one substantially real-time instance. In accordance with this example, the at least one substantially real-time instance may be deemed to have triggered the first mood instance.

At step 406, a determination is made whether the user has a preference corresponding to a first mood that is associated with the first mood instance. For example, the user may prefer to watch cartoons when the user is sad. In accordance with this example, if the first mood indicates that the user is sad, a determination may be made that the user has a preference corresponding to the sad mood. In an example implementation, determination module 506 determines whether the user has the preference corresponding to the first mood that is associated with the first mood instance. If the user has a preference corresponding to the first mood that is associated with the first mood instance, flow continues to step 416. Otherwise, flow continues to step 408.

At step 408, a determination is made whether online content is to be provided to the user based on the first mood instance. In an example implementation, determination module 506 determines whether online content is to be provided to the user. If online content is to be provided to the user based on the first mood instance, flow continues to step 410. Otherwise, flow continues to step 412.

At step 410, online content is provided to the user based on the first mood instance. For instance, if the first mood instance indicates that the user is in a sad mood, online content that the user may find humorous may be provided to the user. In an example implementation, operation module 508 provides the online content to the user.

At step 412, a determination is made whether an action is to be recommended to the user based on the first mood instance. In an example implementation, determination module 506 determines whether an action is to be recommended to the user. If an action is to be recommended to the user, flow continues to step 414. Otherwise, flow continues to step 424, which is shown in FIG. 4B.

At step 414, an action is recommended to the user based on the first mood instance. For example, if the user is in an angry mood, a recommendation may be provided to the user to perform an action that is known to calm the user (e.g., walking the user's dog). In accordance with this example, if conversations between the user and the user's brother are known to anger the user and a determination is made that the user is dialing the brother's telephone number, a recommendation may be provided that the user not call the user's brother (or that the user wait until the user's mood becomes less angry). In an example implementation, operation module 508 recommends the action to the user.

At step 416, a determination is made whether online content is to be provided to the user based on the first mood instance. In an example implementation, determination module 506 determines whether online content is to be provided to the user. If online content is to be provided to the user based on the first mood instance, flow continues to step 418. Otherwise, flow continues to step 420.

At step 418, online content is provided to the user based on the first mood instance and the preference of the user. For example, the user may prefer to watch cartoons when the user is sad. If the first mood instance indicates that the user is sad, videos and/or images of cartoons may be provided to the user. In an example implementation, operation module 508 provides the online content to the user.

At step 420, a determination is made whether an action is to be recommended to the user based on the first mood instance. In an example implementation, determination module 506 determines whether an action is to be recommended to the user. If an action is to be recommended to the user, flow continues to step 422. Otherwise, flow continues to step 424, which is shown in FIG. 4B.

At step 422, an action is recommended to the user based on the first mood instance and the preference of the user. For example, if the user prefers to watch cartoons when the user is sad, and the first mood instance indicates that the user is sad, a recommendation may be provided to the user to watch a cartoon that is airing on a local television channel of the user. In an example implementation, operation module 508 recommends the action to the user.

At step 424, a determination is made whether a cause of the first mood instance is to be determined. In an example implementation, determination module 506 determines whether a cause of the first mood instance is to be determined. If a cause of the first mood instance is to be determined, flow continues to step 426. Otherwise, flow continues to step 462, which is shown in FIG. 4D.

At step 426, the first mood instance is matched to an event that occurs before or concurrently with the first time instance. For example, a statistical relationship between mood instances, which are substantially the same as (or similar to) the first mood instance, and instances of the event that occur before or concurrently with the respective mood instances may be analyzed to match the first mood instance to the event. For instance, a statistical trend may be determined with respect to the instances of the event and the mood instances, which are substantially the same (or similar to) the first mood instance, to indicate a likelihood that the event is the cause of the first mood instance. In an example implementation, matching module 510 matches the first mood instance to the event that occurs before or concurrently with the first time instance.

At step 428, a determination is made that the event is a cause of the first mood instance. For example, the determination may be based on a likelihood that the event is the cause of the first mood instance based on a statistical trend with respect to mood instances, which are substantially the same as (or similar to) the first mood instance, and instances of the event that occur before or concurrently with the respective mood instances. For instance, the determination that the event is the cause of the first mood instance may be based on the likelihood exceeding a threshold value, the likelihood exceeding the likelihood of any other event causing the first mood instance, and/or any other suitable criteria. In an example implementation, causation module 512 determines that the event is a cause of the first mood instance.

At step 430, a determination is made whether a mood indicator is received from the user that indicates a desired mood of the user. In an example implementation, determination module 506 determines whether the mood indicator is received from the user. If the mood indicator is received from the user, flow continues to step 432. Otherwise, flow continues to step 462, which is shown in FIG. 4D.

At step 432, a determination is made whether the mood indicator indirectly indicates the desired mood of the user by indicating a task to be completed by the user. For instance, the task may be associated with the desired mood. Examples of tasks include but are not limited to exercising, cooling down after an exercise session, asking a boss for a raise in salary, taking an examination, etc. In an example implementation, determination module 506 determines whether the mood indicator indirectly indicates the desired mood of the user by indicating a task to be completed by the user. If the mood indicator indirectly indicates the desired mood of the user, flow continues to step 434. Otherwise, flow continues to step 436.

At step 434, a determination is made that the task corresponds to the desired mood. In an example implementation, determination module 506 determines that the task corresponds to the desired mood.

At step 436, a determination is made that the desired mood is substantially same as the first mood that is associated with the first mood instance. In an example implementation, determination module 506 determines that the desired mood is substantially same as the first mood that is associated with the first mood instance.

At step 438, a determination is made whether to provide online content to the user in response to determining that the desired mood is substantially same as the first mood. In an example implementation, determination module 506 determines whether to provide online content to the user in response to determining that the desired mood is substantially same as the first mood. If online content is to be provided to the user, flow continues to step 440. Otherwise, flow continues to step 450, which is shown in FIG. 4D.

At step 440, online content is associated with the first mood based on the first mood instance matching the event. In an example implementation, association module 514 associates the online content with the first mood.

At step 442, the online content that is associated with the first mood is provided to the user. In an example implementation, operation module 508 provides the online content to the user.

At step 444, a determination is made whether an algorithm that is used to determine that the event is a cause of the first mood instance is to be updated. In an example implementation, determination module 506 determines whether the algorithm is to be updated. If the algorithm is to be updated, flow continues to step 446. Otherwise, flow continues to step 450, which is shown in FIG. 4D.

At step 446, a second mood instance of the user is determined that corresponds to a second time instance that occurs after providing online content that is associated with the first mood to the user. In an example implementation, mood module 504 determines the second mood instance.

At step 448, the algorithm is updated based on the second mood instance. For example, equation(s) used to calculate a statistical relationship between mood instances, which are substantially the same as (or similar to) the first mood instance, and instances of the event that occur before or concurrently with the respective mood instances may be updated based on whether a second mood associated with the second mood instance is substantially the same as (or similar to) the desired mood. In an example implementation, update module 516 updates the algorithm.

At step 450, a determination is made whether an action is to be recommended to the user in response to determining that the desired mood is substantially same as the first mood. In an example implementation, determination module 506 determines whether an action is to be recommended to the user.

At step 452, an action is associated with the first mood based on the first mood instance matching the event. The action may include performance of the event, for example, though the scope of the example embodiments is not limited in this respect. In an example implementation, association module 514 associates the action with the first mood.

At step 454, the action that is associated with the first mood is recommended to the user. In an example implementation, operation module 508 recommends the action to the user.

At step 456, a determination is made whether the algorithm that is used to determine that the event is a cause of the first mood instance is to be updated. In an example implementation, determination module 506 determines whether the algorithm is to be updated. If the algorithm is to be updated, flow continues to step 458. Otherwise, flow continues to step 462.

At step 458, a third mood instance of the user is determined that corresponds to a third time instance that occurs after recommending action that is associated with the first mood to the user. In an example implementation, mood module 504 determines the third mood instance.

At step 460, the algorithm is updated based on the third mood instance. For example, equation(s) used to calculate a statistical relationship between mood instances, which are substantially the same as (or similar to) the first mood instance, and instances of the event that occur before or concurrently with the respective mood instances may be updated based on whether a third mood associated with the third mood instance is substantially the same as (or similar to) the desired mood. In an example implementation, update module 516 updates the algorithm.

At step 462, a determination is made whether an event caused by the first mood instance is to be determined. In an example implementation, determination module 506 determines whether an event caused by the first mood instance is to be determined. If an event caused by the first mood instance is to be determined, flow continues to step 464. Otherwise, flow continues to step 468, which is shown in FIG. 4E.

At step 464, the first mood instance is matched to an event that occurs after or concurrently with the first time instance. For example, a statistical relationship between instances of the event that occur after or concurrently with respective mood instances, which are substantially the same as (or similar to) the first mood instance, may be analyzed to match the first mood instance to the event. For instance, a statistical trend may be determined with respect to the instances of the event and the mood instances, which are substantially the same (or similar to) the first mood instance, to indicate a likelihood that the event is caused by the first mood instance. In an example implementation, matching module 510 matches the first mood instance to the event that occurs after or concurrently with the first time instance.

At step 466, a determination is made that the event is caused by the first mood instance. For example, the determination may be based on a likelihood that the event is caused by the first mood instance based on a statistical trend with respect to instances of the event that occur after or concurrently with respective mood instances, which are substantially the same as (or similar to) the first mood instance. For instance, the determination that the event is caused by the first mood instance may be based on the likelihood exceeding a threshold value, the likelihood exceeding the likelihood of any other mood instance causing the event, and/or any other suitable criteria. In an example implementation, causation module 512 determines that the event is caused by the first mood instance.

At step 468, a determination is made whether to generate a mood log associated with the user. A mood log is a list of mood instances and corresponding time instances with respect to a user. In an example implementation, determination module 506 determines whether to generate a mood log. If a mood log is to be generated, flow continues to step 470. Otherwise, flow continues to step 472.

At step 470, a mood log associated with the user is generated. The mood log includes the first mood instance and the corresponding first time instance. The mood log may further include other mood instances and/or substantially real-time instance(s) that are associated with the user. In an example implementation, log module 518 generates the mood log. In accordance with this example implementation, log module 518 may be configured to analyze the mood log to determine patterns of moods that are triggered by events and/or patterns of events that are triggered by moods. For instance, log module 518 may analyze the mood log in substantially real-time and/or in batch.

At step 472, a determination is made whether a mood graph is to be generated that shows relationships between a plurality of moods and a plurality of respective triggers that cause the moods. A mood graph is a graphical representation of moods of a user and triggers that cause the moods. In an example implementation, determination module 506 determines whether a mood graph is to be generated. If a mood graph is to be generated, flow continues to step 474. Otherwise, flow continues to step 476, which is shown in FIG. 4F.

At step 474, a mood graph is generated. The mood graph shows relationships between a plurality of moods and a plurality of respective triggers that cause the moods. Each trigger is a respective person, place, thing (e.g., online advertisement, automobile, animal, desk, food, etc.), or action. Relationships may exist in any dimension of the mood graph, including diagonally between the plurality of moods and the plurality of respective triggers. For example, the mood graph may assist the user in determining why the user is in a particular mood based on any one or more of the plurality of triggers. For instance, the user may be in a bad mood all day after a call from a particular relative, but may not connect the call with being in the bad mood. The mood graph may indicate that the user commonly is in a bad mood for two days after a call from that particular relative. Based on this indication, the user may take steps to improve the user's mood and/or understand the cause of the bad mood that a call from the relative elicits. In an example implementation, graph module 520 generates the mood graph.

At step 476, a determination is made whether the user is a member of an online community. An online community may include users who live in a particular country, state, city, or other graphical region; users who have a common interest or hobby; users who are members of a particular service or organization; users who have a common occupation or employer; or any other suitable grouping of people. In an example implementation, determination module 506 determines whether the user is a member of an online community. If the user is a member of an online community, flow continues to step 478. Otherwise, flowchart 400 ends.

At step 478, a determination is made whether a statistic regarding a mood of the online community is to be generated. In an example implementation, determination module 506 determines whether a statistic regarding the mood of the online community is to be generated. If a statistic regarding the mood of the online community is to be generated, flow continues to step 480. Otherwise, flowchart 400 ends.

At step 480, a statistic regarding the mood of the online community is generated based on the first mood instance and mood instances of other respective members of the online community. For example, the statistic may indicate a collective (e.g., average) mood of the online community based on the mood instances of the respective members of the online community. In another example, the statistic may indicate a variety of moods of the members of the online community that correspond to the respective mood instances of the members. For instance, the statistic may indicate a proportion of the members who are associated with each respective mood. In an example implementation, statistics module 522 generates the statistic regarding the mood of the online community.

In some example embodiments, one or more steps 402, 404, 406, 408, 410, 412, 414, 416, 418, 420, 422, 424, 426, 428, 430, 432, 434 436, 438, 440, 442, 444, 446, 448, 450, 452, 454, 456, 458, 460, 462, 464, 466, 468, 470, 472, 474, 476, 478, and/or 480 of flowchart 400 may not be performed. Moreover, steps in addition to or in lieu of steps 402, 404, 406, 408, 410, 412, 414, 416, 418, 420, 422, 424, 426, 428, 430, 432, 434 436, 438, 440, 442, 444, 446, 448, 450, 452, 454, 456, 458, 460, 462, 464, 466, 468, 470, 472, 474, 476, 478, and/or 480 may be performed.

It will be recognized that Web server 106′ may not include one or more of receiving module 502, mood module 504, determination module 506, operation module 508, matching module 510, causation module 512, association module 514, update module 516, log module 518, graph module 520, and/or statistics module 522. Furthermore, Web server 106′ may include modules in addition to or in lieu of receiving module 502, mood module 504, determination module 506, operation module 508, matching module 510, causation module 512, association module 514, update module 516, log module 518, graph module 520, and/or statistics module 522.

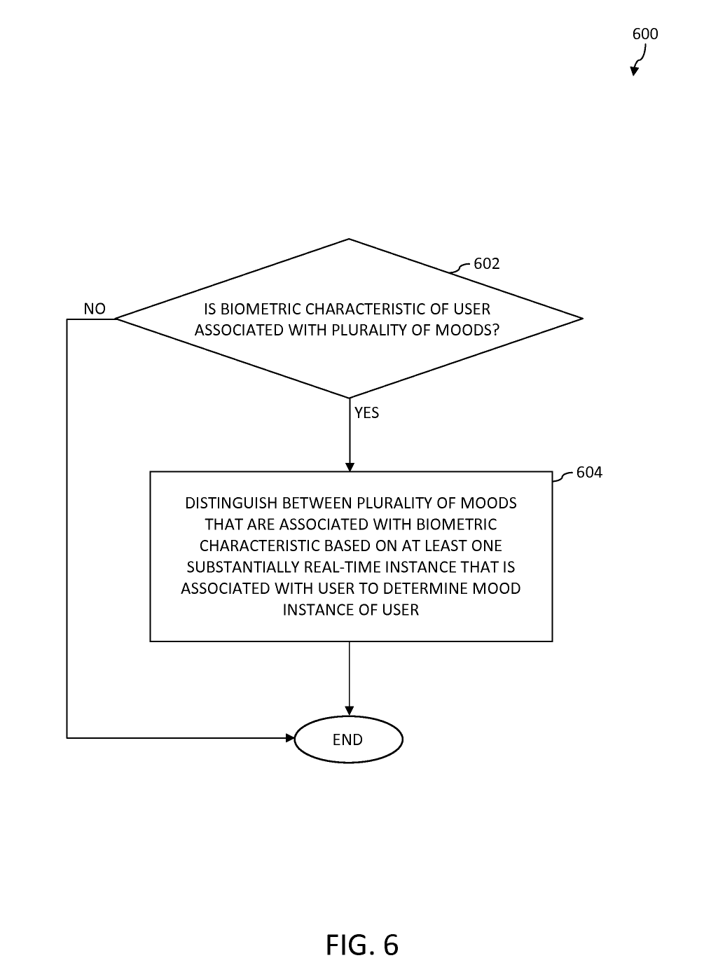

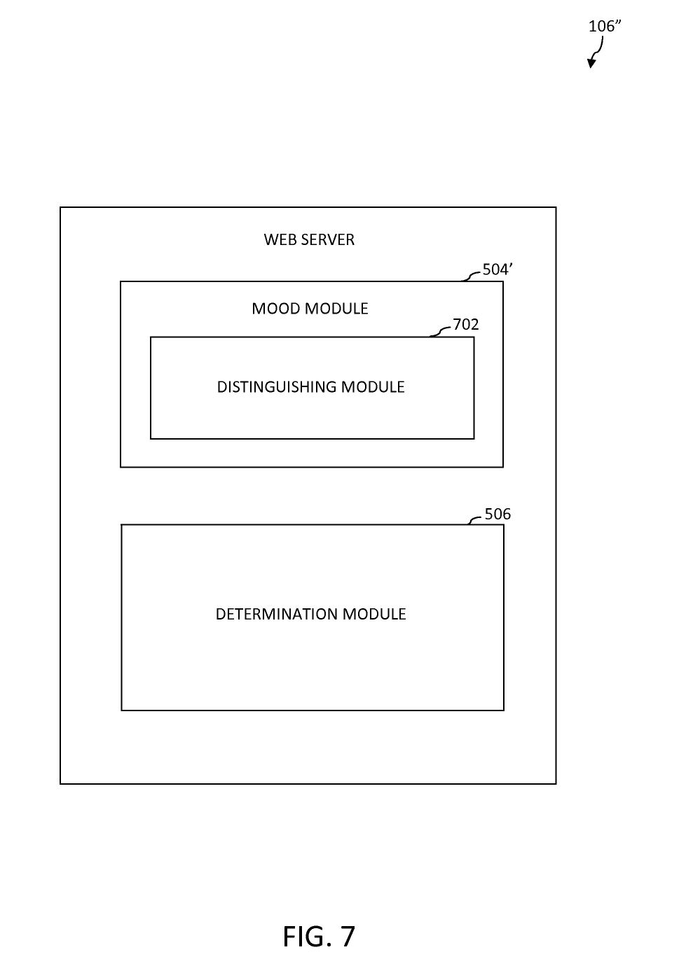

FIG. 6 depicts a flowchart 600 of a method for determining a mood instance of a user in accordance with an embodiment described herein. Flowchart 600 may be performed by any of Web servers 106A-106N of online system 100 shown in FIG. 1, for example. For illustrative purposes, flowchart 600 is described with respect to a Web server 106″ shown in FIG. 7, which is an example of a Web server 106, according to an embodiment. As shown in FIG. 7, Web server 106″ includes a mood module 504′ and a determination module 506. Mood module 540′ includes a distinguishing module 702. Further structural and operational embodiments will be apparent to persons skilled in the relevant art(s) based on the discussion regarding flowchart 600. Flowchart 600 is described as follows.

As shown in FIG. 6, the method of flowchart 600 begins at step 602. In step 602, a determination is made whether a biometric characteristic of a user is associated with a plurality of moods. For example, an elevated heart rate may be associated with anxiety, fear, exhaustion, excitement, etc. In an example implementation, determination module 506 may determine whether the biometric characteristic of the user is associated with a plurality of moods. If the biometric characteristic is associated with a plurality of moods, flow continues to step 604. Otherwise, flowchart 600 ends.

At step 604, a distinction is made between the plurality of moods that are associated with the biometric characteristic based on at least one substantially real-time instance that is associated with the user to determine the mood instance of the user. In the example above in which the user has an elevated heart rate, if the at least one substantially real-time instance includes the user walking through a haunted house, a distinction made be made between the plurality of moods that are associated with an elevated heart rate to determine that the user is frightened. In an example implementation, distinguishing module 702 distinguishes between the plurality of moods that are associated with the biometric characteristic to determine the mood instance of the user.

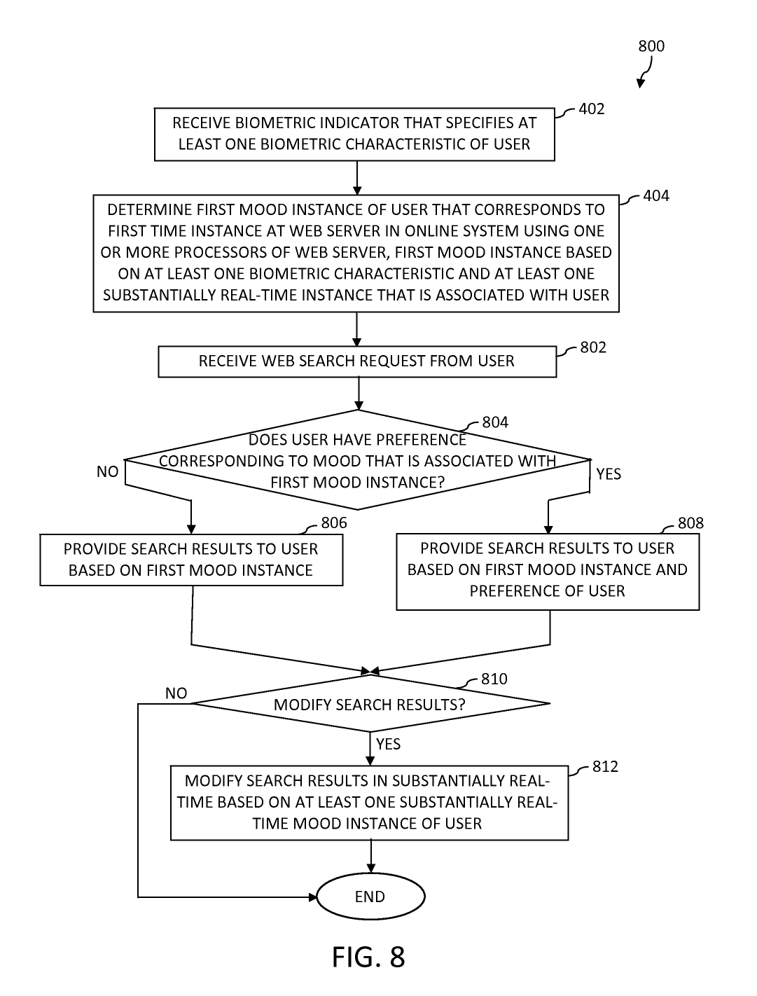

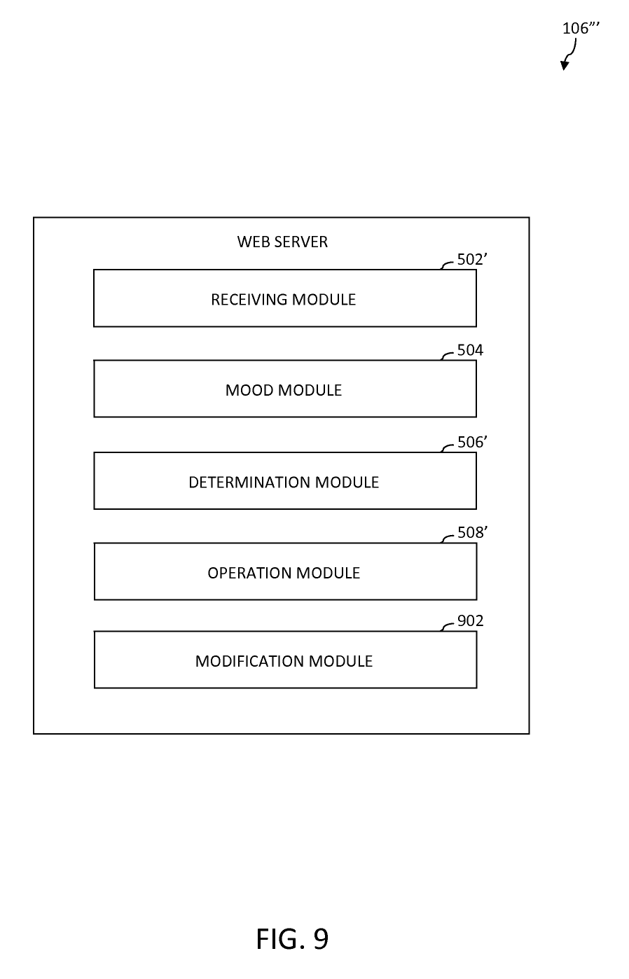

FIG. 8 depicts a flowchart 800 of a method for providing search results to a user based on a mood of the user in accordance with an embodiment described herein. Flowchart 800 may be performed by any of Web servers 106A-106N of online system 100 shown in FIG. 1, for example. For illustrative purposes, flowchart 800 is described with respect to a Web server 106′″ shown in FIG. 9, which is an example of a Web server 106, according to an embodiment. As shown in FIG. 9, Web server 106′″ includes a receiving module 502′, a mood module 504, a determination module 506′, an operation module 508′, and a modification module 902. Further structural and operational embodiments will be apparent to persons skilled in the relevant art(s) based on the discussion regarding flowchart 800. Flowchart 800 is described as follows.

As shown in FIG. 8, the method of flowchart 800 begins at step 402. In step 402, a biometric indicator that specifies at least one biometric characteristic of a user is received. In an example implementation, receiving module 502′ receives the biometric indicator.

At step 404, a first mood instance of the user that corresponds to a first time instance is determined at a Web server in an online system using one or more processors of the Web server. The first mood instance is based on the at least one biometric characteristic and at least one substantially real-time instance that is associated with the user. In an example implementation, mood module 504 determines the first mood instance of the user.

At step 802, a Web search request is received from the user. In an example implementation, receiving module 502′ receives the Web search request from the user.

At step 804, a determination is made whether the user has a preference corresponding to a mood that is associated with the first mood instance. In an example implementation, determination module 506′ determines whether the user has the preference corresponding to the mood that is associated with the first mood instance. If the user has a preference corresponding to the mood that is associated with the first mood instance, flow continues to step 808. Otherwise, flow continues to step 806.

At step 806, search results are provided to the user based on the first mood instance. In an example implementation, operation module 508′ provides the search results to the user.

At step 808, search results are provided to the user based on the first mood instance and the preference of the user. In an example implementation, operation module 508′ provides the search results to the user.

In response to completion of step 806 or step 808, flow continues to step 810. At step 810, a determination is made whether the search results are to be modified. In an example implementation, determination module 506′ determines whether the search results are to be modified. If the search results are to be modified, flow continues to step 812. Otherwise, flowchart 800 ends.

At step 812, the search results are modified in substantially real-time based on at least one substantially real-time mood instance of the user. For example, as the user observes the search results, the search results may change based on the user's contentment with the search results. The contentment of the user may be determined based on mood instance(s) of the user. For instance, the user may become more or less content as the user reads the search results. In accordance with this example, the search results may continue to change until the mood instance(s) of the user indicate that the user is relatively more content.

In another example, change buttons may be associated with respective search result entries. In accordance with this example, each change button may be green or red. Selecting a change button changes the color from green to red or from red to green, depending on the initial color of the change button. A graphical user interface may be provided to the user, showing the change buttons with respect to the search result entries. The graphical user interface may be configured to enable the user to select the color of each change button to be red or green. A green change button indicates that the user does not desire to change the corresponding search result. A red change button indicates that the user does desire to change the corresponding search result. In accordance with this example, only search result entries associated with a red change button are changed. In an example implementation, modification module 902 modifies the search results.

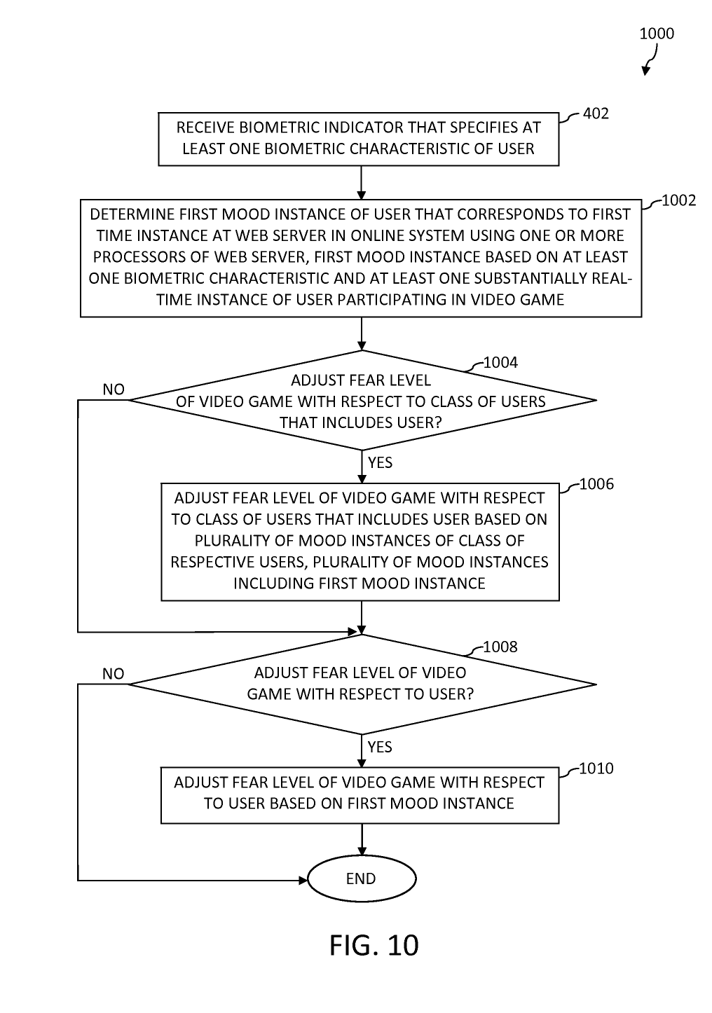

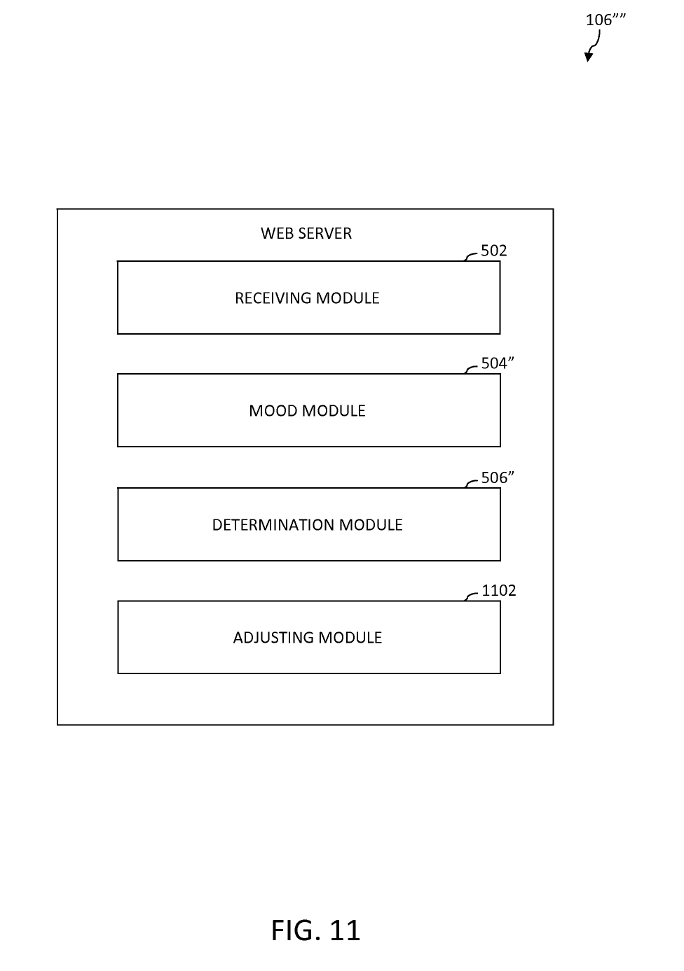

FIG. 10 depicts a flowchart 1000 of a method for adjusting fear level of a video game in accordance with an embodiment described herein. Flowchart 1000 may be performed by any of Web servers 106A-106N of online system 100 shown in FIG. 1, for example. For illustrative purposes, flowchart 1000 is described with respect to a Web server 106″″ shown in FIG. 11, which is an example of a Web server 106, according to an embodiment. As shown in FIG. 11, Web server 106″″ includes a receiving module 502, a mood module 504″, a determination module 506″, and an adjusting module 1102. Further structural and operational embodiments will be apparent to persons skilled in the relevant art(s) based on the discussion regarding flowchart 1000. Flowchart 1000 is described as follows.

As shown in FIG. 10, the method of flowchart 1000 begins at step 402. In step 402, a biometric indicator that specifies at least one biometric characteristic of a user is received. In an example implementation, receiving module 502 receives the biometric indicator.

At step 1002, a first mood instance of the user that corresponds to a first time instance is determined at a Web server in an online system using one or more processors of the Web server. The first mood instance is based on the at least one biometric characteristic and at least one substantially real-time of the user participating in a video game. In an example implementation, mood module 504″ determines the first mood instance of the user.

At step 1004, a determination is made whether a fear level of the video game is to be adjusted with respect to a class of users that includes the user. In an example implementation, determination module 506″ determines whether the fear level of the video game is to be adjusted with respect to the class. In an example, it may be assumed that the user is a five-year-old child. Determination module 506″ may include information that indicates that five-year-old children generally are frightened by the introduction of bullets in the video game. Accordingly, determination module 506″ may determine that the fear level of the video game is to be lowered (e.g., bullets are not to be introduced) with respect to a class that includes five-year-old children. It will be recognized that steps 402 and 1002 need not necessarily be performed in order to determine whether the fear level of the video game is to be adjusted with respect to the class of users that includes the user. If the fear level is to be adjusted with respect to the class, flow continues to step 1006. Otherwise, flow continues to step 1008.

At step 1006, the fear level of the video game is adjusted with respect to the class of users that includes the user based on a plurality of mood instances of the class of respective users. The plurality of mood instances includes the first mood instance. In an example implementation, adjusting module 1102 adjusts the fear level of the video game with respect to the class.

At step 1008, a determination is made whether the fear level of the video game is to be adjusted with respect to the user. In an example implementation, determination module 506″ determines whether the fear level of the video game is to be adjusted with respect to the user. For example, determination module 506″ may determine that the introduction of bullets resulted in the user being frightened. Accordingly, determination module 506″ may determine that the fear level of the video game is to be lowered (e.g., no further bullets are to be introduced) with respect to the user. If the fear level is to be adjusted with respect to the user, flow continues to step 1010. Otherwise, flowchart 1000 ends.

At step 1010, the fear level of the video game is adjusted with respect to the user based on the first mood instance. In an example implementation, adjusting module 1102 adjusts the fear level of the video game with respect to the user.

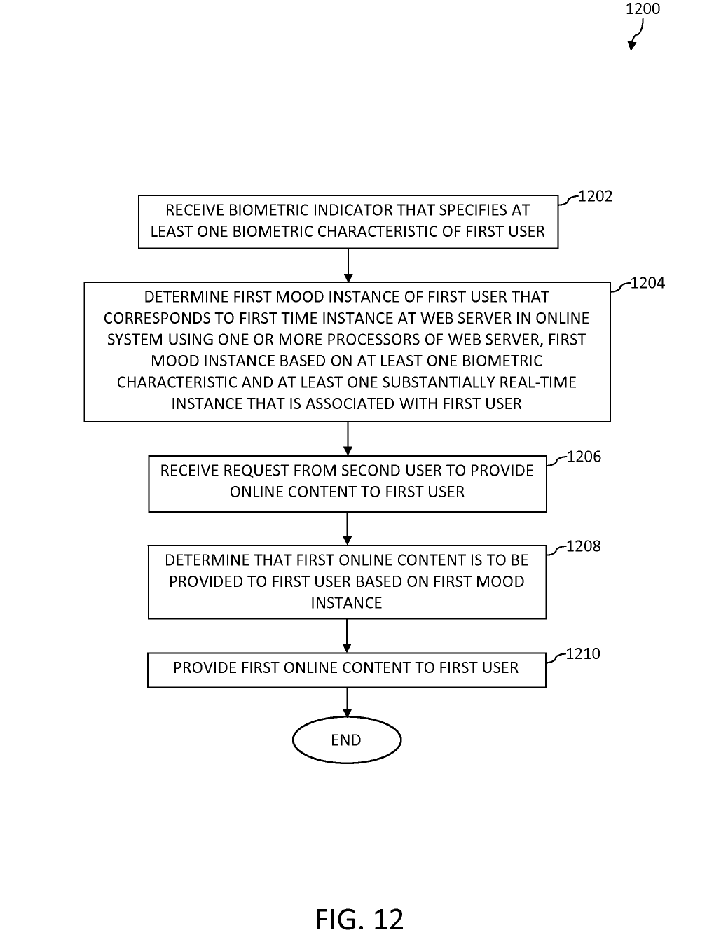

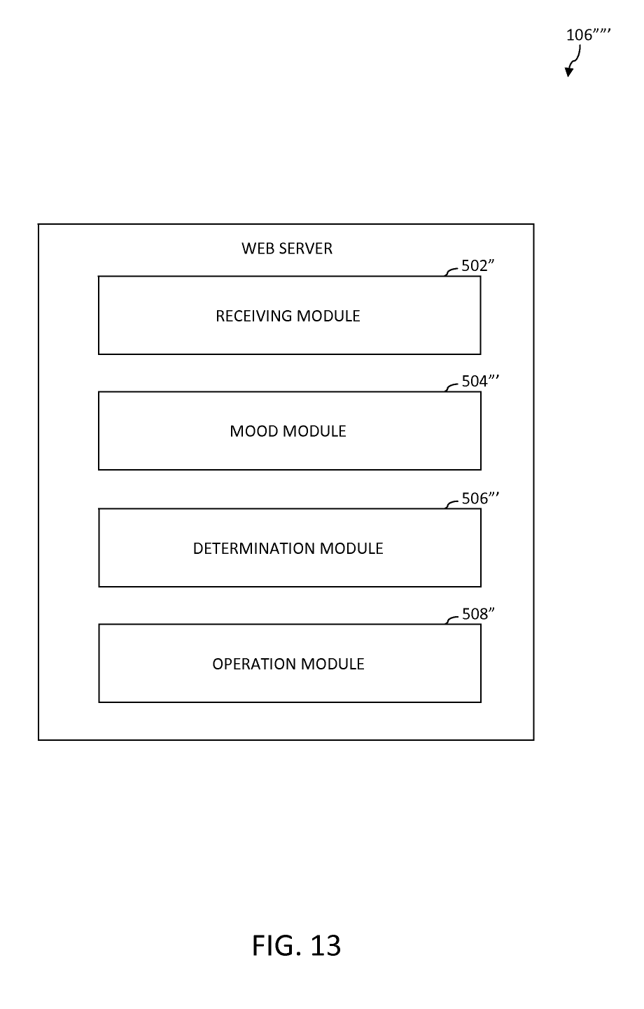

FIG. 12 depicts a flowchart 1200 of a method for providing online content to a user based on a mood of the user in accordance with an embodiment described herein. Flowchart 1200 may be performed by any of Web servers 106A-106N of online system 100 shown in FIG. 1, for example. For illustrative purposes, flowchart 800 is described with respect to a Web server 106′″″ shown in FIG. 13, which is an example of a Web server 106, according to an embodiment. As shown in FIG. 13, Web server 106′″″ includes a receiving module 502″, a mood module 504′″, a determination module 506′″, and an operation module 508″. Further structural and operational embodiments will be apparent to persons skilled in the relevant art(s) based on the discussion regarding flowchart 1200. Flowchart 1200 is described as follows.

As shown in FIG. 12, the method of flowchart 1200 begins at step 1202. In step 1202, a biometric indicator that specifies at least one biometric characteristic of a first user is received. In an example implementation, receiving module 502″ receives the biometric indicator.

At step 1204, a first mood instance of the first user that corresponds to a first time instance is determined at a Web server in an online system using one or more processors of the Web server. The first mood instance is based on the at least one biometric characteristic and at least one substantially real-time instance that is associated with the first user. For example, the at least one substantially real-time instance may be the inclusion of political commentary in an RSS feed that is provided to the user. In accordance with this example, the first mood instance may indicate that the inclusion of the political commentary angers the user. In an example implementation, mood module 504′″ determines the first mood instance of the user.

At step 1206, a request is received from a second user to provide online content to the first user. In an example implementation, receiving module 502″ receives the request from the second user.

At step 1208, a determination is made that first online content is to be provided to the first user based on the first mood instance. In accordance with the example provided above, in which the inclusion of political commentary in the user's RSS feed angered the user, the determination may be made to provide non-political commentary to the user's RSS feed. Alternatively, political commentary may be prioritized such that non-political commentary is provided to the user before the political commentary. In an example implementation, determination module 506′″ determines that the first online content is to be provided to the first user.

At step 1210, the first online content is provided to the first user. In accordance with the example provided above, the non-political commentary is provided to the user's RSS feed to the exclusion of the political commentary, or the non-political commentary is provided before the political commentary. In an example implementation, operation module 508″ provides the first online content to the first user.

### III. Example Computer Implementation

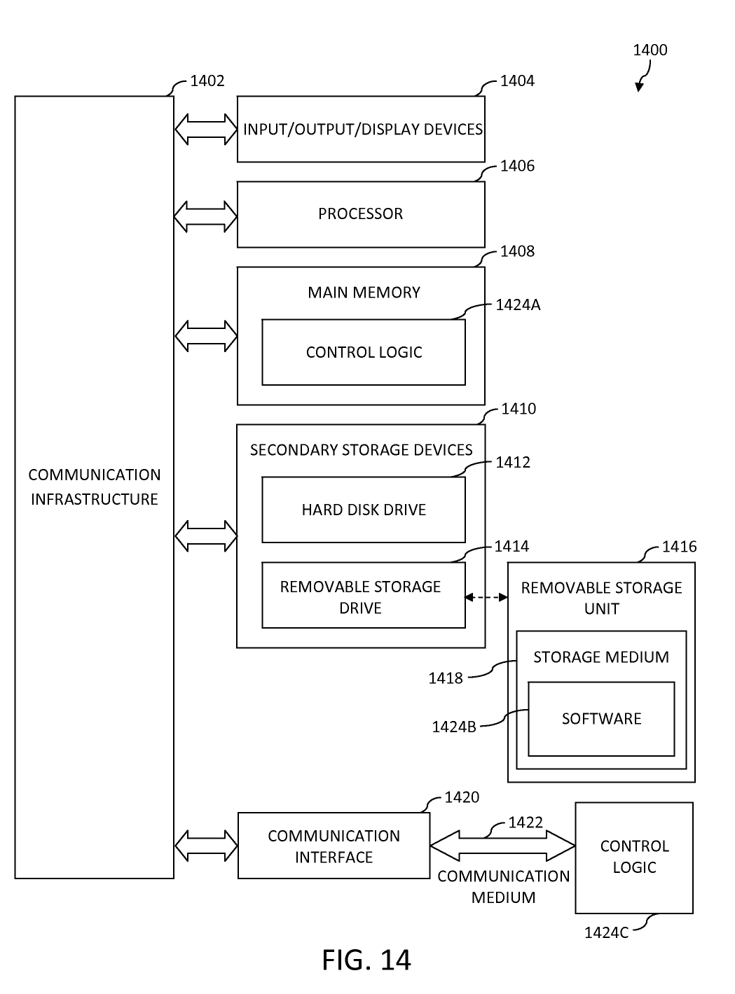

The embodiments described herein, including systems, methods/processes, and/or apparatuses, may be implemented using well known computers, such as computer 1400 shown in FIG. 14. For example, elements of example online system 100, including user systems 102A-102M depicted in FIGS. 1 and 3 and elements thereof, Web servers 106A-106N depicted in FIGS. 1, 5, 7, 9, 11, and 13 and elements thereof, and each of the steps of flowcharts 200, 400, 600, 800, 1000, and 1200 depicted in respective FIGS. 2, 4A-4F, 6, 8, 10, and 12, can each be implemented using one or more computers 1400.

Computer 1400 can be any commercially available and well known computer capable of performing the functions described herein, such as computers available from International Business Machines, Apple, Sun, HP, Dell, Cray, etc. Computer 1400 may be any type of computer, including a desktop computer, a server, etc.

As shown in FIG. 14, computer 1400 includes one or more processors (e.g., central processing units (CPUs)), such as processor 1406. Processor 1406 may include indicator module 304 of FIG. 3; online content module 306 of FIG. 3; receiving module 502 of FIGS. 5, 9, 11, and 13; mood module 504 of FIGS. 5, 7, 9, 11, and 13; determination module 506 of FIGS. 5, 7, 9, 11, and 13; operation module 508 of FIGS. 5, 9, and 13; matching module 510 of FIG. 5; causation module 512 of FIG. 5; association module 514 of FIG. 5; update module 516 of FIG. 5; log module 518 of FIG. 5; graph module 520 of FIG. 5; statistics module 522 of FIG. 5; distinguishing module 702 of FIG. 7; modification module 902 of FIG. 9; or adjusting module 1102 of FIG. 11; or any portion or combination thereof, for example, though the scope of the embodiments is not limited in this respect. Processor 1406 is connected to a communication infrastructure 1402, such as a communication bus. In some embodiments, processor 1406 can simultaneously operate multiple computing threads.

Computer 1400 also includes a primary or main memory 1408, such as a random access memory (RAM). Main memory has stored therein control logic 1424A (computer software), and data.

Computer 1400 also includes one or more secondary storage devices 1410. Secondary storage devices 1410 include, for example, a hard disk drive 1412 and/or a removable storage device or drive 1414, as well as other types of storage devices, such as memory cards and memory sticks. For instance, computer 1400 may include an industry standard interface, such as a universal serial bus (USB) interface for interfacing with devices such as a memory stick. Removable storage drive 1414 represents a floppy disk drive, a magnetic tape drive, a compact disk drive, an optical storage device, tape backup, etc.

Removable storage drive 1414 interacts with a removable storage unit 1416. Removable storage unit 1416 includes a computer useable or readable storage medium 1418 having stored therein computer software 1424B (control logic) and/or data. Removable storage unit 1416 represents a floppy disk, magnetic tape, compact disc (CD), digital versatile disc (DVD), Blue-ray disc, optical storage disk, memory stick, memory card, or any other computer data storage device. Removable storage drive 1414 reads from and/or writes to removable storage unit 1416 in a well known manner.

Computer 1400 also includes input/output/display devices 1404, such as monitors, keyboards, pointing devices, biometric sensors, etc. It should be noted that any one or more biometric sensors may be incorporated into another input/output/display device, such as a monitor, keyboard, pointing device, etc.

Computer 1400 further includes a communication or network interface 1420. Communication interface 1420 enables computer 1400 to communicate with remote devices. For example, communication interface 1420 allows computer 1400 to communicate over communication networks or mediums 1422 (representing a form of a computer useable or readable medium), such as local area networks (LANs), wide area networks (WANs), the Internet, etc. Network interface 1420 may interface with remote sites or networks via wired or wireless connections. Examples of communication interface 1422 include but are not limited to a modem, a network interface card (e.g., an Ethernet card), a communication port, a Personal Computer Memory Card International Association (PCMCIA) card, etc.

Control logic 1424C may be transmitted to and from computer 1400 via the communication medium 1422.

Any apparatus or manufacture comprising a computer useable or readable medium having control logic (software) stored therein is referred to herein as a computer program product or program storage device. This includes, but is not limited to, computer 1400, main memory 1408, secondary storage devices 1410, and removable storage unit 1416. Such computer program products, having control logic stored therein that, when executed by one or more data processing devices, cause such data processing devices to operate as described herein, represent embodiments of the invention.

For example, each of the elements of example Web server 106 and its sub-elements, including indicator module 304 depicted in FIG. 3; online content module 306 depicted in FIG. 3; receiving module 502 depicted in FIGS. 5, 9, 11, and 13; mood module 504 and determination module 506, each depicted in FIGS. 5, 7, 9, 11, and 13; operation module 508 depicted in FIGS. 5, 9, and 13; matching module 510, causation module 512, association module 514, update module 516, log module 518, graph module 520, and statistics module 522, each depicted in FIG. 5; distinguishing module 702 depicted in FIG. 7; modification module 902 depicted in FIG. 9; adjusting module 1102 depicted in FIG. 11; and each of the steps of flowcharts 200, 400, 600, 800, 1000, and 1200 depicted in respective FIGS. 2, 4A-4F, 6, 8, 10, and 12 can be implemented as control logic that may be stored on a computer useable medium or computer readable medium, which can be executed by one or more processors to operate as described herein.

The invention can be put into practice using software, hardware, and/or operating system implementations other than those described herein. Any software, hardware, and operating system implementations suitable for performing the functions described herein can be used.

### IV. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method comprising:
receiving a biometric indicator that specifies at least one biometric characteristic of a first user; and
determining a first mood instance of the first user that corresponds to a first time instance at a Web server in an online system using one or more processors of the Web server, the first mood instance based on the at least one biometric characteristic and at least one substantially real-time instance that is associated with the first user.

2. The method of claim 1, further comprising:
receiving a Web search request from the first user; and
providing search results to the first user based on the first mood instance of the first user in response to receiving the Web search request.

3. The method of claim 2, wherein providing the search results is further based on a preference of the first user corresponding to a mood that is associated with the first mood instance.

4. The method of claim 2, further comprising:
modifying the search results in substantially real-time based on at least one substantially real-time mood instance of the first user.

5. The method of claim 1, wherein determining the at least one biometric characteristic comprises:
performing a scent analysis with respect to the first user.

6. The method of claim 1, wherein the at least one substantially real-time instance includes a substantially real-time media instance that is associated with the first user.

7. The method of claim 6, wherein the substantially real-time media instance comprises:
participation by the first user in a video game;
the method further comprising:
adjusting a fear level of the video game with respect to the first user based on the first mood instance.

8. The method of claim 6, wherein the substantially real-time media instance comprises:
participation by the first user in a video game;
the method further comprising:
adjusting a fear level of the video game with respect to a class of users that includes the first user based on a plurality of mood instances of the class of respective users, the plurality of mood instances including the first mood instance.

9. The method of claim 1, wherein the at least one substantially real-time instance includes a substantially real-time geographic instance that is associated with the first user, the substantially real-time geographic instance indicating a substantially real-time geographic location of the first user.

10. The method of claim 1, further comprising:
receiving a request from a second user to provide online content to the first user;
determining that first online content is to be provided to the first user based on the first mood instance; and
providing the first online content to the first user in response to receiving the request from the second user.

11. The method of claim 1, wherein determining the first mood instance comprises:
distinguishing between a plurality of moods that are associated with the at least one biometric characteristic based on the at least one substantially real-time instance to determine the first mood instance.

12. The method of claim 1, wherein determining the first mood instance of the first user comprises:
determining the first mood instance of the first user who is a member of an online community; and
wherein the method further comprises:
generating a statistic regarding a mood of the online community based on the first mood instance and mood instances of other respective members of the online community.

13. The method of claim 1, further comprising:
matching the first mood instance to an event that occurs after or concurrently with the first time instance; and
determining that the first mood instance is a cause of the event.

14. The method of claim 1, further comprising:
matching the first mood instance to an event that occurs before or concurrently with the first time instance; and
determining that the event is a cause of the first mood instance.

15. The method of claim 14, further comprising:
receiving a mood indicator from the first user that indicates a desired mood of the first user;
determining that the desired mood is substantially the same as a first mood that is associated with the first mood instance;
associating online content with the first mood based on the first mood instance matching the event; and
providing the online content to the first user in response to determining that the desired mood is substantially the same as the first mood.

16. The method of claim 15, wherein receiving the mood indicator comprises:
receiving the mood indicator that indicates a task to be completed by the first user; and
determining that the task corresponds to the desired mood.

17. The method of claim 15, further comprising:
determining a second mood instance of the first user that corresponds to a second time instance that occurs after providing the online content to the first user; and
updating an algorithm that is used to determine that the event is the cause of the first mood instance based on the second mood instance.

18. The method of claim 14, further comprising:
receiving a mood indicator from the first user that indicates a desired mood of the first user;
determining that the desired mood is substantially the same as a first mood that is associated with the first mood instance;
associating an action with the first mood based on the first mood instance matching the event; and
recommending the action to the first user in response to determining that the desired mood is substantially the same as the first mood.

19. A Web server comprising:
a receiving module configured to receive a biometric indicator that specifies at least one biometric characteristic of a user; and
a mood module configured to determine a first mood instance of the user that corresponds to a first time instance based on the at least one biometric characteristic and at least one substantially real-time instance that is associated with the user.

20. The system of claim 19, further comprising:
an operation module configured to provide online content to the user or recommend an action to the user, based on the first mood instance.

21. The system of claim 20, wherein the operation module is configured to provide the online content to the user or recommend the action to the user, further based on a preference of the user corresponding to a mood that is associated with the first mood instance.

22. The system of claim 19, further comprising:
a determination module configured to determine a task to be completed by the user, the determination module further configured to determine that a mood corresponds to the task; and
an operation module configured to provide online content to the user or recommend an action to the user, based on the mood that corresponds to the task.

23. The system of claim 19, further comprising:
a graph module configured to generate a mood graph that shows relationships between a plurality of moods of the user and a plurality of respective triggers that cause the moods;
wherein each trigger is a respective person, place, thing, or action.

24. The system of claim 19, further comprising:
a log module configured to generate a mood log associated with the user, the mood log including the first mood instance and the corresponding first time instance.

25. A method comprising:
sensing at least one biometric characteristic of a user;
providing a biometric indicator that specifies the at least one biometric characteristic to a Web server in an online system;
providing a real-time instance indicator that specifies at least one substantially real-time instance that is associated with the user to the Web server; and
processing online content that is received from the Web server at a user system in the online system using one or more processors of the user system, the online content based on the at least one biometric characteristic of the user and the at least one substantially real-time instance that is associated with the user.

26. The method of claim 25, wherein sensing the at least one biometric characteristic of the user is performed using a ring sensor.

27. The method of claim 25, wherein sensing the at least one biometric characteristic of the user is performed using a key sensor.

28. The method of claim 25, wherein sensing the at least one biometric characteristic of the user is performed using a pointing device sensor.
